(19) United States
(12) Patent Application Publication
(10) Pub. No.: US 2010/0096547 A1
(43) Pub. Date: Apr. 22, 2010

(54) Method for classifying and separating particles, and device for carrying out said method

(75) Inventors: Günter Allmaier, Wien (AT); Wladyslaw W. Szymanski, Pressbaum (AT); Georg Reischl, Wien (AT); Christian Laschober, Wien (AT)

Correspondence Address: CHAPMAN AND CUTLER, 111 WEST MONROE STREET, CHICAGO, IL, 60603, US

(73) Assignees: Universität Wien, Wien (AT); Technische Universität Wien, Wien (AT)

(21) Appl. No.: 11/989,873

(22) PCT Filed: Jul. 26, 2006
(86) PCT No.: PCT/AT2006/000321

§ 371 Date: Oct. 22, 2008

(30) Foreign Application Priority Data
Aug. 5, 2005 (AT) A 1327/2005
Jan. 24, 2006 (AT) A 108/2006

(51) Int. Cl. H01J 49/28; B01D 59/44

(52) U.S. Cl. 250/283; 250/282; 250/294

(57) ABSTRACT

In a method for classifying and separating particles in a fluid stream in which the particles are sprayed and electrically charged and deflected in an electrical field one portion of the stream of the charged or ionized particles respectively is introduced into a first separation device operated as an analyzer (4) and is deflected under variation of the applied high voltage or the electric field respectively, whereby particles reach a detector chamber (10) according to separation criteria like, for example charge or particle size. This high voltage and/or field strength corresponding to a species collected in the detector chamber (10) is read and/or stored as a reference value. The particle stream is fed into a separator (5), in which the previously acquired high voltage and/or field strength is applied and particles of the species deflected in the analyzer (4) into the detector chamber (10) are enriched and discharged correspondingly.

The invention relates to a method for classifying and separating particles in a fluid stream, in which the particles are sprayed and electrically charged and deflected in an electrical field as well as to a device for carrying out said method.

In the following molecules, molecule-assemblies, nano-particles and fragments of matter, which can be present charged, uncharged or as radicals are understood as particles.

A number of devices have been proposed for the separation of small particles. Electrosprayaerosol-generators in which water-soluble or suspendable, non volatile particles and fluid are used, to generate particles by spraying, are to be named first as products available on the market. In such a device each spray droplet is dried to a particle, which can be subsequently ejected as an aerosol with a carrier gas. Standard devices thereby reach a particle generation rate of 10⁷ particles per cm³, whereby the applied electrical voltage generates at first extremely small, charged particles, which are neutralized in an ionisation chamber, in particular by utilization of radioactive rays, before the aerosol leaves the generator.

However, as a rule, only a more or less polydisperse aerosol is obtainable with such devices and particles of different sizes in varying size distributions are present. Even though with appropriate electrosprayaerosol-generators the size distribution as well as the size of the particles can be kept relatively small, it is not possible with such devices to generate or analyze respectively defined particles of a uniform size.

To subsequently further separate such polydisperse aerosols in the submicrometer range, standard differential mobility analyzers (DMA) have become known, which allow the separation of particles of a chosen size or mass respectively as a monodisperse aerosol from a polydisperse aerosol. Such DMAs are designed as electrostatic separators, whereby a polydisperse aerosol is at first ionized or charged respectively and subsequently deflected according to the velocity of the flow, the mass and the charge towards a central electrode in the interior of such a DMA. The central electrode of such DMA'S is, as a rule, charged negatively in the known devices, such that positively charged particles can exclusively be acquired or collected respectively. If a passage aperture is supplied in the region of the electrodes for the trajectory of a certain charged particle of a certain size, it is possible to extract particles of an exactly defined size from such a DMA. Neutral particles as well as negative particles cannot be acquired witch such a device, whereby the electrical mobility is the criterion for the corresponding deflection. A defined trajectory of a particle with a defined charge and a defined size can be laid out by application of different voltages or different electrical fields respectively. With respect to the polydisperse submicrometeraerosols a size distribution spectrum can be recorded by variation of the electrical voltage, because particles of different size are emitted at different voltages.

The invention aims to provide a device of the initially mentioned kind, with which it is possible not only to determine the size distribution and the pro-rata amounts of differing particle sizes in a polydisperse aerosol, but also to allow a selective enrichment of monodisperse aerosols with certain defined characteristics in accordance with the found size distributions. To solve this object, the method according to the invention substantially consists therein, that one portion of the stream of the charged or ionized particles respectively is introduced into an analyzer and is deflected under variation of the applied high voltage or the electrical field respectively, whereby the particles reach a detection chamber according to separation criteria like, for example, charge or particle size, that a high voltage and/or field strength corresponding to a species collected in a detector chamber is read and/or stored as a reference value and that the particle stream is then fed into a separator separate from the analyzer in which the previously acquired high voltage and/or field strength is applied and particles of the species deflected in the analyzer into the detector chamber are enriched and discharged correspondingly. By also using a corresponding separator along with an analyzer and by also separating the species acquired in the analyzer in each case on the basis of the applied high voltage or field strength respectively as reference value in the separator identical in construction, it can on the one hand be safeguarded that a certain species is present at a certain applied voltage in the analyzer, whose more detailed examination is subsequently only possible after enrichment. For the mere qualitative analysis, which amounts or which particle size distribution exist in the polydisperse particle stream, a simple detection chamber, with which for example, only the accumulated charge is integratedly measured, is sufficient in the analyzer. However, such an analysis automatically leads to neutralisation of particles and therefore does not allow for subsequently discharging such particles selectively and, for example, to conform them to a form appropriate for quantitative or detailed analysis.

For examination under an electron microscope, a greater amount of such particles can advantageously be collected on a corresponding carrier and above all, it must be safeguarded, that the particles collected in this manner are particles of a uniform size, in order to make assertions about the particles to be analyzed under an electron microscope. In that the particles following the respective separation criteria can be discharged as charged particles and as a monodisperse aerosol flow when applying an identical high voltage and/or field strength in the separator, the possibility is provided to electrostatically collect these monodisperse aerosols on a precipitator, whereby here again the possibility is provided to carry out precipitation of separated ions or nanoparticles respectively directly on a grid or a membrane and to subsequently conduct other specific measurements with such enriched monodisperse particles like, for example, mass spectrometric, immunologic, functional, optical or electromicroscopical examinations. Hereby it is substantial that a continuous enrichment and thus a corresponding greater amount of monodisperse aerosols for the collection of identical particles in greater amounts is achieved and thus the provision of an adequate sample for further examinations is made possible.

In a particularly advantageous manner, the embodiment is devised such, that the detection chamber is designed as a Faraday-cage and that the electrical charge introduced into the detector chamber along with the particles is measured over time and is used as a measure for the accumulated particle number or particle mass respectively in the collection chamber per unit time. Such a charge measurement over time results in a measured current, which subsequently at first allows to predict the existence of a certain particle mass or a certain particle size respectively. Further information can hardly be gathered from the outcome of such a detector chamber.

In order to safeguard that identical conditions are present in the analyzer and the separator and by application of identical electrical parameters like, for example, high voltage or field strength, the same monodisperse particle streams are thus actually achievable in the separator, the method is advantageously carried out such, that the particles introduced into the analyzer and the separator along with the fluid stream are conducted in a laminar flow, whereby preferably the carrier fluid is pumped in a closed loop for the maintenance of a laminar flow in the analyzer and the separator and is thermally controlled or cooled respectively to the same temperature. A slight increase in temperature of the laminar flow pumped in a closed loop can occur due to the used pumps, such that it is of paramount importance to thermally control or cool respectively both loops to be at the same temperature for identical conditions in the analyzer and the separator.

As already mentioned, it is a fundamental object of the method according to the invention to enrich a certain species for further examinations or even generate them in greater amounts, whereby to this end according to the invention it is advantageously proceeded such, that the particles enriched in the separator are deposited on a corresponding carrier and discharged along with it.

Advantageously, the method according to the invention is carried out such, that standard differential mobility analyzers that have been selected in pairs are used. This configuration immediately permits to carry out an enrichment in addition to the precise detection of separation criteria suitable for a classification or separation respectively without further alteration. Simultaneously a quality control can naturally be carried out, if such enriched particles are at least partially fed back to the analyzer, to verify the achieved purity or uniformity respectively of the enriched particles by a further variation of the applied high voltage or the electric field respectively. Such a feedback is in particular of notable interest if the enriched particles are subjected to a treatment, which should influence the characteristics of the discharged particles. To this end according to the invention it is advantageously proceeded such that the particles leaving the separator are subjected to a chemical and/or thermal treatment and/or a treatment using electromagnetic or particle radiation and are subsequently discharged. Such a treatment can in particular be carried out for biological materials like, for example, proteins for the separation of fragments. In particular it can, for example, be possible to separate viral proteins in order to achieve in this way products, which are not pathogenic. The chemical treatment, in turn, can lead to a docking of biologic material onto corresponding docking sites. For example, for the purpose of a modification in a treatment chamber, the attachment of immunoglobulins can be allowed for or a series of chemicals can allow for an adequate modification of the enriched particles.

To verify the result of such a modification by said treatment method, the method according to the invention permits in a particularly simple manner to carry out a further separation of the generated fragments or bigger particles respectively generated by deposition in the analyzer available parallel thereto in the type of finger prints. To this end, the method according to the invention is advantageously carried out such, that the particles subjected to the treatment are ionized in amounts sufficient for analytic purposes and are fed back to the analyzer for the determination of a characteristic spectrum under variation of the voltage and/or the electric field.

The device according to the invention used for the carrying out said method reverts to known equipment. The essence hereby is the specific wiring of known devices to a device for carrying out a method according to the invention which essentially consists, according to the invention, in that an electrospray- or aerosol-generator respectively is connected with two parallely or alternatively chargeable differential mobility analyzers (DMA) with an ionizer or a particle charging station respectively, being interposed and that a measurement device is connected to one of the DMA's for the registration of the particles which reach the measurement device at a defined electrical field or defined electrical voltage respectively and that the electrical voltage or the electrical field respectively corresponding to the measured particles is linked to corresponding actuators in the second DMA and that a collection chamber is situated at the exit of the second DMA.

The embodiment is hereby advantageously devised such that a device for electrostatic separation of the particles selected by the chosen voltage is subsequently connected to the second DMA, whereby the separation electrode of the device for electrostatic separation of the particles is formed by an electron-microscopegrid or as a membrane.

The above mentioned modification of the discharged particles according to the invention is carried out in a particularly simple manner in a separate treatment chamber, to which end the embodiment is advantageously devised such that the discharge opening of the second DMA is connected to a treatment chamber for the discharged species. For the further analysis of the products generated in the treatment chamber, the embodiment is in a particularly advantageous manner devised such, that a feed-back line is arranged between the discharge opening of the treatment chamber and the feed-in opening of the first DMA by which feed-back line the treated species is selectively fed to the DMA embodied as an analyzer. If in the effected treatment the originally present electrical charges have been neutralized, an adequate ionisation has to be carried out for the further analysis in the analyzer, whereby the embodiment can be devised such that an ionizer is interposed in the feed-back line.

The invention will now be described by way of an exemplary embodiment, schematically illustrated in the drawing. In this

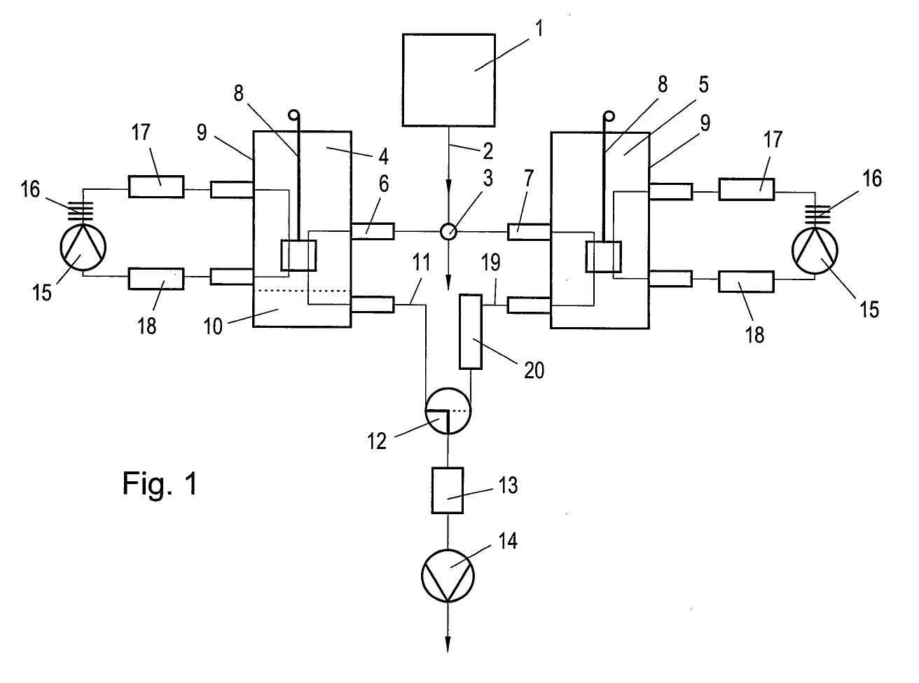

FIG. 1 shows a schematic drawing of a device according to the invention for carrying out the method according to the invention,

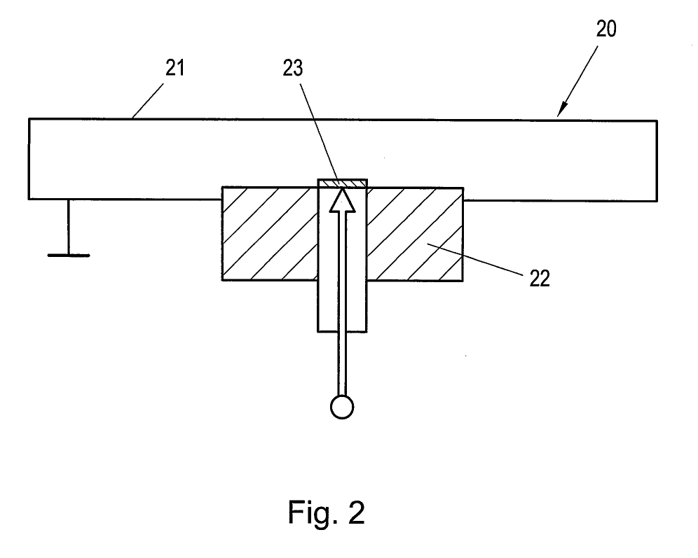

FIG. 2 a section of an electrostatic nanoparticle separator,

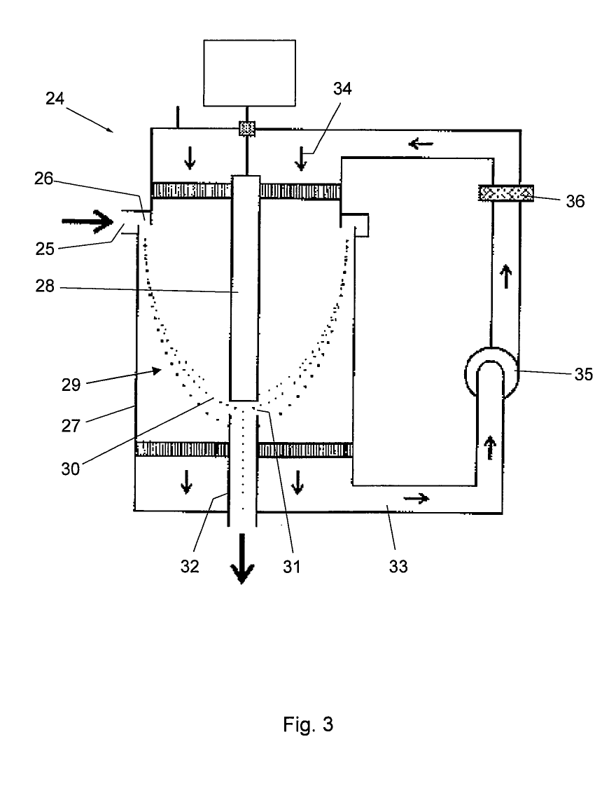

FIG. 3 an enlarged depiction of a standard differential mobility analyzer as it can be used for particles having a diameter in the nanometer range and

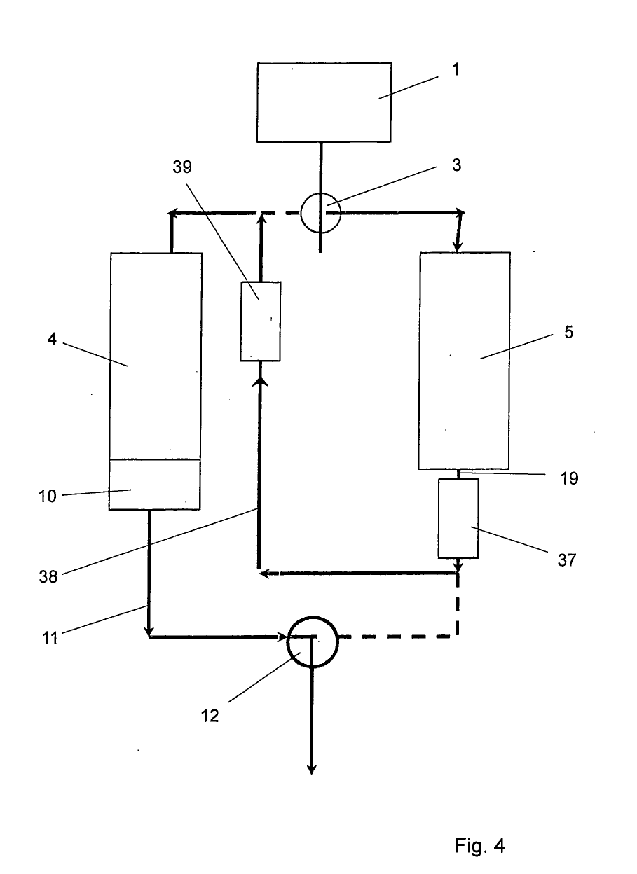

FIG. 4 a schematic depiction of a modified device incorporating post-processing of the discharged species.

In FIG. 1 a standard electrospray-generator is denoted by 1. The dried and electrostatically sprayed particles reach a valve 3 as an aerosol in a fluid stream via a pipe 2 and can hereby selectively be fed in a first differential mobility analyzer 4 connected as an analyzer or a second differential mobility analyzer 5 connected as an enrichment separator. The fluid streams are introduced into the electrostatic separators via feed-in openings, schematically denoted by 6 or 7 respectively, whereby in each case high voltage is applied to a central electrode 8. The housing 9 of the DMA's, which are in principle identical in construction, is grounded. A mixture of positively or negatively respectively charged and neutral particles is fed in via the ports 6 or 7 respectively, whereby charged particles are deflected towards a central electrode 8 and collected there correspondingly. Schematically the collection occurs in the first DMA 4 in a Faraday-cage 10, whereby the adequately neutralized mixture can be extracted via a pipe 11 and a valve 12, a filter 13 and a pump 14. According to the applied high voltage a classification by size in the nanometer to micrometer range occurs in this DMA 4, whereby a laminar flow is maintained by a fluid stream in a closed loop to which end a pump 15, a cooler 16 and a filter 17 are employed for the recycling of the fluid. The corresponding parts are named in identical manner also for the second DMA 5, whereby in both cases before entry into the pumps 15, a corresponding unit 18 comprising a dryer, a charcoal filter and an absolute filter is connected upstream to safeguard, that merely fluid but no unwanted particles is carried in the closed loop.

After verification that when applying a certain voltage to the electrode a corresponding amount of monodisperse particles of the polydisperse aerosol introduced via the port 6 has reached the detection chamber devised as a Faraday-cage, the enrichment can be effected by application of an identical voltage to the electrode of the second DMA 5, to which end only the valve 3 has to be adequately switched and the aerosol is now led to the second DMA 5 via the port 7. The still charged particles can here be extracted for example via the port 19 and fed into an electrostatic nanoparticle sampler 20, depicted enlarged in FIG. 2. In order to also safeguard here a laminar flow, the valve 12 in this case must also be switched to ensure a directed flow.

The electrostatic nanoparticle-sampler 20 depicted in FIG. 2 in an enlarged scale, in the simplest case is a grounded metallic chamber 21, in which a built-in electrode 23 is held with an isolator 22 being interposed. The electrode in turn has a corresponding high voltage applied to and has a collection surface which allows for direct further use of the enriched and separated particles, for example in electronmicroscopy or in an immunoanalysis.

In FIG. 3, the design of a DMA is depicted in detail. Such a DMA 24 has a port 25 for the introduction of polydisperse sub-micrometerparticles, which flow into the DMA 24 via an annular channel 26 forming a laminar flow. The wall 27 of the DMA is grounded, whereby positively charged particles are deflected in a direction towards a central negatively charged electrode 28. The resulting particle trajectory 29 corresponding to the mass and the particle size as well as the applied voltage in each case is schematically denoted by 30 for a certain species. Only a species of defined particle size or particle mass respectively reaches the passage slit 31 below the electrode 28 at a defined voltage and can be collected via the channel 32 and be discharged. The laminar flow is sustained by a gas guided in a closed loop via the port 33, which forms a laminar stream sheathing corresponding to the arrows 34 on the outside of the essentially cylindrical electrode 28. A pump 35 is provided for the circulation of the gas, whereby a filter 36 caters for an adequate purification. Excess gas can be discharged via a separate port. In this embodiment it results that a polydisperse aerosol which is introduced via the port 25 at a defined voltage applied to the electrode 28 leads to a monodisperse aerosol at the outlet of the pipe 32 which aerosol subsequently can be subjected to an accumulated deposition.

In FIG. 4 the same reference numerals have been used for the same parts. There, instead of the nanoparticle-sampler described heretofore a treatment chamber 37 serving as a sampler and modifier is connected to the differential mobility analyzer 5 which caters for the enrichment. In this treatment chamber 37 adequate treatment methods can be performed on the enriched particles to which end chemicals can be introduced or the treatment chamber is simply heated. Ultimately electromagnetic rays or particle rays can be used in the treatment chamber 37. The adequately modified products, which can have both a bigger particle size due to agglomeration and be decayed in a number of smaller particles due to chipping or shattering, can now be fed back to the first differential mobility analyzer 4, designed as an analyzer, via the pipe 38 in which a further ionizer 39 can be interposed. Here again a spectrum or a finger print respectively is generated of the particles formed after the treatment and a further enrichment of the desired species after the treatment can be effected by corresponding switching of the valve 3 or 12 respectively.

In total this thus results in a particularly easy quality control and examination of the conversions effected in the treatment chamber by a further analysis of the resulting fragments, modified nanoparticles or agglomerates respectively, whereby at each time, knowing the desired species, a corresponding enrichment can be effected. In this case, it is sufficient to simply connect the treatment chamber 37 as sampler and to establish an adequate field for the separation.

1. Method for classifying and separating particles in a fluid stream, comprising the steps of:
spraying the particles;
electrically charging the particles; and
deflecting the particles in an electrical field,
thereby producing a stream of charged or ionized particles, wherein one portion of the stream of charged or ionized particles respectively
is introduced into a first separation device operating as an analyzer, and
is deflected under variation of an applied high voltage or electric field respectively, whereby particles reach a detector chamber according to separation criteria,
one or more of high voltage and field strength corresponding to a species collected in the detector chamber is one or more of read and stored as a reference value, and
the stream is then fed into a separation device separate from the analyzer and operating as a separator, in which the previously acquired one or more of high voltage and field strength is applied, and particles of a species deflected in the analyzer into the detector chamber are enriched and discharged correspondingly.

2. Method according to claim 1, wherein
the detector chamber is a Faraday-cage, and
an electrical charge introduced into the detector chamber along with the particles is measured over time and is used as a measure for accumulated particle number or particles mass respectively in a collection chamber per unit time.

3. Method according to claim 1, wherein
the particles discharged from the separator
are subjected to one or more of a chemical treatment, a thermal treatment, an electromagnetic treatment, and a particle radiation treatment, and
are subsequently discharged.

4. Method according to claim 3, wherein the particles subjected to said one or more treatments
are ionized in amounts sufficient for analytic purposes, and
are fed back to the analyzer for determination of a characteristic spectrum under variation of said one or more of voltage and field strength.

5. Method according to claim 1, wherein the particles introduced into the analyzer and the separator along with the fluid stream are conducted in a laminar flow.

6. Method according to claim 5, wherein a carrier fluid is pumped in a chosen loop for maintenance of the laminar flow in the analyzer and the separator, and is thermally controlled or cooled respectively, in order to be at the same temperature.

7. Method according to claim 1, wherein the particles enriched in the separator are deposited on a surface of a carrier and are discharged with the carrier.

8. Device for classifying and separating particles in a fluid stream, comprising:
an electro spray- or aerosol generator (1) respectively connected with two parallely or alternatively chargeable differential mobility analyzers (DMAs) (4, 5);
a first one (4) of said DMAs operating as an analyzer and a second one (5) of said DMAs operating as a separator;
an ionizer or particle charge station interposed between said two DMAs (4, 5); and
a detector chamber (10) connected to the first one of the DMAs (4) for registration of the particles which reach the detector chamber (10) in a defined electrical field or defined electrical voltage respectively, wherein
a voltage or an electrical field respectively corresponding to the registered particles is linked to corresponding actuators in the second one of the DMAs (5), and
a collection chamber (20) is arranged at an exit of the second one of the DMAs (5).

9. Device according to claim 8, further comprising a device for electrostatic separation of particles selected by the defined electrical field or defined electrical voltage, connected to the second one of the DMAs (5).

10. Device according to claim 8, wherein a discharge opening (19) of the second one of the DMAs (5) operating as a separator is connected to a treatment chamber (37) for treatment of a discharged species.

11. Device according to claim 10, wherein a feed back line (38) is arranged between a discharge opening of the treatment chamber (37) and a feeding opening of the first one of the DMAs (4) operating as an analyzer, by which feed back line the treated species is selectively fed to the first one of the DMAs (4) operating as an analyzer.

12. Device according to claim 11, further comprising an ionizer (39) interposed in the feed back line (38) between the first one (4) and the second one (5) of the DMAs.

13. Device according to claim 9, wherein a separation electrode (23) of the device for electrostatic separation of the particles is an electron-microscopegrid or a membrane.

14. Method according to claim 1, wherein the separation criteria are one or more of charge and particle size.

15. Method according to claim 2, wherein
the particles discharged from the separator
are subjected to one or more of a chemical treatment, a thermal treatment, an electromagnetic treatment, and a particle radiation treatment, and
are subsequently discharged.

16. Method according to claim 2, wherein the particles introduced into the analyzer and the separator along with the fluid stream are conducted in a laminar flow.

17. Method according to claim 3, wherein the particles introduced into the analyzer and the separator along with the fluid stream are conducted in a laminar flow.

18. Method according to claim 4, wherein the particles introduced into the analyzer and the separator along with the fluid stream are conducted in a laminar flow.

19. Method according to claim 2, wherein the particles enriched in the separator are deposited on a surface of a carrier and are discharged with the carrier.

20. Method according to claim 3, wherein the particles enriched in the separator are deposited on a surface of a carrier and are discharged with the carrier.
